(19) United States
(12) Patent Application Publication
(10) Pub. No.: US 2020/0230871 A1
(43) Pub. Date: Jul. 23, 2020

(54) THREE-DIMENSIONAL STRUCTURE FORMING METHOD

(71) Applicant: MIMAKI ENGINEERING CO., LTD., Nagano (JP)

(72) Inventors: Akira IKEDA, NAGANO (JP); YOSHIROU SUGIMOTO, NAGANO (JP); Kunio Hakkaku, NAGANO (JP)

(73) Assignee: MIMAKI ENGINEERING CO., LTD., Nagano (JP)

(21) Appl. No.: 16/842,726

(22) Filed: Apr. 7, 2020

Related U.S. Application Data
(63) Continuation of application No. 14/791,484, filed on Jul. 6, 2015.

(30) Foreign Application Priority Data
Jul. 7, 2014 (JP) 2014-139978

(51) Int. Cl. B29C 64/112; B29C 64/386; B33Y 50/02; B33Y 30/00; B33Y 10/00

(52) U.S. Cl. CPC B29C 64/112; B29C 64/386; B33Y 10/00; B33Y 30/00; B33Y 50/02

(57) ABSTRACT

A three-dimensional structure forming method is provided for forming a three-dimensional structure including an object and a colored region in which a surface of the object is colored, by using a three-dimensional structure forming device equipped with a recording unit and a maintenance unit for laminating layers formed by depositing ink, and the three-dimensional structure forming method includes a recording step of causing the recording unit to perform scans, and discharging the ink from the recording unit during the scans to form the layers; and a preliminary discharging step of preliminarily discharging the ink from the recording unit while being between a position to be performed maintenance by the maintenance unit and a position to start to form the layers.

### CROSS REFERENCE TO RELATED APPLICATIONS

This application is a continuation of and claims the priority benefit of U.S. patent application Ser. No. 14/791,484, filed on Jul. 6, 2015, and claims the priority benefit of Japan application serial no. 2014-139978, filed on Jul. 7, 2014. The entirety of the above-mentioned patent application is hereby incorporated by reference herein and made a part of this specification.

### TECHNICAL FIELD

The present disclosure relates to a three-dimensional structure forming device and a forming method, and more specifically, relates to a forming device and a forming method for forming a three-dimensional structure by forming layers by depositing ink and laminating the layers.

### DESCRIPTION OF THE BACKGROUND ART

Aside from an inkjet method as in JP 2001-18297 A (published on Jan. 23, 2001), a technique that forms a three-dimensional structure by using a molten deposition method (FDM: Fused Deposition Modeling), an inkjet binder method, a sheet lamination method, an optical modeling method (SL: Stereo Lithography), a powder sintering method (SLS: Selective Laser Sintering), or the like is known.

Among them, as an inkjet method, a method that jets out UV curing resin by a 3D printer and laminates patterns is widely used. This method creates data, by using three-dimensional CAD, of design, mechanism and the like of an outer and inner appearances of a final product, and thereafter creates multilayer type of pattern data in which the data is sliced and thin plates are overlapped one another by a computer, and forms the three-dimensional structure by jetting out the UV curing resin from a head and laminating the same according to the pattern data. Further, at the same time as the forming, decoration (patterns and colors) such as a full-color coloring is performed.

### SUMMARY

### Problem to be Solved

As to a three-dimensional forming by a conventionally known inkjet method, the inventors of the present application tried forming a three-dimensional object that is color-decorated by discharging ink for forming and ink for decoration (coloring ink, for example, such as yellow, magenta, cyan, black and the like) by an inkjet method, using a laminating method, and it has been found that there are cases where the three-dimensional structure cannot be formed accurately.

In seeking for the cause therefor, it has been found that the discharge is unstable just after when the ink discharge has started (a droplet volume of the discharge may not be of a defined amount, a discharging direction may be curved, the discharge does not function, and the like), which causes trouble in a layer thickness formation, as a result of which undesirable influence is imposed on the final three-dimensional structure. Thus, the inventors of the present application have discovered a technique that improves forming accuracy based on this finding, and has come to complete the disclosure of the present application.

That is, the present disclosure has been made in view of the above problem, and provides a forming device and a forming method by which a three-dimensional structure can be formed highly accurately.

### Solutions to the Problem

To solve the above problem, according to the present disclosure, a three-dimensional structure forming device is characteristic in being a three-dimensional structure forming device for forming a three-dimensional structure including an object and a colored portion in which a surface of the object is colored, by laminating layers formed by depositing ink, and the three-dimensional structure forming device includes: a recording unit that discharges the ink during at least one scan to form one of the layers; a maintenance unit that performs maintenance on the recording unit; and a control unit that controls the recording unit, wherein the control unit controls the recording unit to preliminarily discharge the ink while being between a position to be performed the maintenance by the maintenance unit and a position to start to form the layers.

According to the above configuration, ink discharge can be performed under a predetermined discharging condition from the start of layer formation, and a forming device that can form a three-dimensional structure highly accurately can be provided.

Specifically, according to the above configuration of the present disclosure, the recording unit is configured to preliminarily discharge ink while being between the position to receive maintenance and the position to start layer formation. Due to this, the ink discharging condition of the recording unit can be brought to a state suitable for layer formation just before the layer formation.

For example, when there is a period during which ink is not discharged before starting the ink discharge for layer formation, there are cases where the ink discharging condition of the recording unit changes in an undesirable manner, such as by nozzle holes for discharging the ink of the recording unit becoming dry. However, according to the above configuration of the present disclosure, since ink is preliminarily discharged before layer formation, this preliminary ink discharge can optimize the ink discharging condition of the recording unit. Due to this, layer formation can be started under the optimal ink discharging condition.

Thus, according to the forming device of the present disclosure, the layers can accurately be formed.

It should be noted that this applies similarly from immediately after the maintenance until the start of layer formation. That is, even if the recording unit comes to be in a satisfactory state by having performed maintenance, nozzle holes of inkjet heads for which discharge data has not been provided for a long time may be dried by airflow caused by scans before when the discharge is started, and in some cases the satisfactory state cannot be maintained. Even in such a case, by having the configuration of the present disclosure, ink can be discharged under the predetermined discharging condition at the start of layer formation, whereby layers can accurately be formed.

Further, in one aspect of the three-dimensional structure forming device according to the present disclosure, in addition to the above configuration, the control unit controls the recording unit to preliminarily discharge the ink for each of the at least one scan.

According to the above configuration, since preliminary ink discharge is performed for each of at least one scan, layer formation can more accurately be performed.

Further, in one aspect of the three-dimensional structure forming device according to the present disclosure, in addition to the above configuration, the recording unit discharges one or more types of object-forming ink for forming the object and one or more types of coloring ink for forming the colored portion, as the ink, from inkjet heads provided respectively, and the control unit controls the recording unit to preliminarily discharge the ink from at least one of the inkjet heads.

Further, in one aspect of the three-dimensional structure forming device according to the present disclosure, in addition to the above configuration, the control unit controls the recording unit to preliminarily discharge ink from the inkjet head provided for the coloring ink.

According to the above configuration, since the ink for configuring the colored portion is discharged preliminarily, color tone of the three-dimensional structure is controlled highly accurately, and a three-dimensional structure with a desired color tone can be provided.

Further, in one aspect of the three-dimensional structure forming device according to the present disclosure, in addition to the above configuration, the recording unit discharges supporting material ink that is not contained in the three-dimensional structure, and causes the supporting material ink to deposit along an outer circumference of the layers for each of the at least one scan, and the control unit controls the recording unit to cause the ink that is preliminarily discharged to deposit within a deposited region of the supporting material ink.

According to the above configuration, since the preliminarily discharged ink is deposited in the deposit of the supporting material ink, the preliminarily discharged ink can be removed at the same time upon removing the deposit of the supporting material ink. Due to this, the preliminarily discharged ink does not need to be removed in a separately, and a forming process can be simplified.

Further, in one aspect of the three-dimensional structure forming device according to the present disclosure, in addition to the above configuration, a stage for depositing ink discharged from the recording unit is further provided, wherein the ink that is preliminarily discharged by the recording unit may strike onto the stage.

According to the above configuration, ink that is preliminarily discharged is caused to strike onto the stage for forming a three-dimensional structure. Due to this, compared to a case of preliminarily discharging ink on the maintenance unit, ink can be preliminarily discharged in the vicinity of the three-dimensional structure, so that the nozzle drying in the recording unit can be suppressed, and defects regarding discharge can further be suppressed.

Further, in one aspect of the three-dimensional structure forming device according to the present disclosure, in addition to the above configuration, a discharging amount of the ink that is preliminarily discharged per unit area may be less than a discharging amount of the ink discharged for forming one of the layers per unit area.

According to the above configuration, by reducing the ink that is preliminarily discharged, ink consumption can be suppressed.

To solve the above problem, according to the present disclosure, a three-dimensional structure forming method for forming a three-dimensional structure including an object and a colored portion in which a surface of the object is colored, by laminating layers formed by depositing ink using a three-dimensional structure forming device that is provided with a recording unit and a maintenance unit is characteristic in including: a recording step of causing the recording unit to perform at least one scan, and forming at least one of the layers by discharging the ink from the recording unit during the at least one scan; and a preliminary discharging step of preliminarily discharging the ink from the recording unit while being between a position to be performed maintenance by the maintenance unit and a position to start to form layers.

According to the above configuration, a forming device that can perform ink discharge under a predetermined discharging condition from the start of the layer formation and form a three-dimensional structure highly accurately can be provided.

Specifically, according to the above configuration of the present disclosure, the recording unit is configured to preliminarily discharge ink while being between the position to receive maintenance and the position to start layer formation. Due to this, the ink discharging condition of the recording unit can be brought to a state suitable for the layer formation just before the layer formation.

For example, when there is a period during which ink is not discharged before starting the ink discharge for layer formation, there are cases where the ink discharging condition of the recording unit changes in an undesirable manner, such as by nozzle holes for discharging the ink of the recording unit becoming dry. However, according to the above configuration of the present disclosure, since ink is preliminarily discharged before the layer formation, this preliminary ink discharge can optimize the ink discharging condition of the recording unit. Due to this, the layer formation can be started under the optimal ink discharging condition.

Thus, according to the forming device of the present disclosure, the layers can accurately be formed.

It should be noted that this applies similarly from immediately after maintenance until the start of layer formation. That is, even if the recording unit comes to be in a satisfactory state by having performed maintenance, nozzle holes of inkjet heads for which discharge data has not been provided for a long time may be dried by airflow caused by scans before when the discharge is started, and in some cases the satisfactory state cannot be maintained. Even in such a case, by having the configuration of the present disclosure, ink can be discharged under the predetermined discharging condition at the start of layer formation, whereby layers can accurately be formed.

An embodiment of the disclosure provides a three-dimensional structure forming method for forming a three-dimensional structure including an object and a colored region in which a surface of the object is colored, by using a three-dimensional structure forming device equipped with a recording unit and a maintenance unit for laminating layers formed by depositing ink, and the three-dimensional structure forming method including: a recording step of causing the recording unit to perform scans, and discharging the ink from the recording unit during the scans to form the layers; and a preliminary discharging step of preliminarily discharging the ink from the recording unit while being between a position to be performed maintenance by the maintenance unit and a position to start to form the layers.

In one aspect of the three-dimensional structure forming method according to the present disclosure, the preliminary discharging step is performed for each of the scans.

In one aspect of the three-dimensional structure forming method according to the present disclosure, the recording step discharges one or more types of object-forming ink for forming the object and one or more types of coloring ink for forming the colored region, as the ink, from inkjet heads provided respectively, and the preliminary discharging step discharges the ink from at least one of the inkjet heads.

In one aspect of the three-dimensional structure forming method according to the present disclosure, the preliminary discharging step discharges the ink from the inkjet head provided for the coloring ink.

In one aspect of the three-dimensional structure forming method according to the present disclosure, the recording step discharges supporting material ink that is not contained in the three-dimensional structure, and causes the supporting material ink to deposit along an outer circumference of the layers for each of the scans, and the ink that is discharged by the preliminary discharging step is deposited within a deposited region of the supporting material ink.

In one aspect of the three-dimensional structure forming method according to the present disclosure, further including: providing a stage for depositing the ink that is discharged, wherein the ink of the preliminary discharging step strikes onto an upper surface of the stage.

In one aspect of the three-dimensional structure forming method according to the present disclosure, a discharging amount per unit area of the ink in the preliminary discharging step is less than a discharging amount per unit area of the ink discharged for forming one of the layers.

In one aspect of the three-dimensional structure forming method according to the present disclosure, the recording step discharges supporting material ink that is not contained in the three-dimensional structure, and causes the supporting material ink to deposit along an outer circumference of the layers for each of the scans to form a supporting material. The supporting material supports or holds the three-dimensional structure in a forming process, and is removed in a post-processing. The ink discharged in the preliminary discharging step is discharged in the supporting material or at a position outside the supporting material, and is discharged at a position outside a portion of the supporting material.

In one aspect of the three-dimensional structure forming method according to the present disclosure, the recording step discharges the ink based on multilayer pattern data. The preliminary discharging step discharges the ink from the recording unit based on data different from the multilayer pattern data.

### Advantageous Effect of the Disclosure

According to the present disclosure, stabilized ink discharge can be performed upon layer formation by preliminarily discharging the ink before the layer formation, and the three-dimensional structure can be formed highly accurately.

### BRIEF DESCRIPTION OF THE DRAWINGS

FIG. 1A is a perspective view of a three-dimensional structure formed by one embodiment of a forming device for forming the three-dimensional structure according to the present disclosure, and FIG. 1B is a partial cross sectional view taken along arrows of FIG. 1A.

FIG. 2 is a diagram showing one embodiment of the forming device for forming the three-dimensional structure according to the present disclosure.

FIG. 3 is a diagram showing a lower surface of a recording unit that is a part of the forming device shown in FIG. 2.

FIG. 4 is a diagram showing a state during a forming process using the forming device shown in FIG. 2.

FIG. 5 is a plan view showing one specific layer among a plurality of layers formed by the forming process using the forming device shown in FIG. 2, and a periphery thereof.

FIG. 6 is a diagram showing a variation of a part of the forming process using the forming device shown in FIG. 2.

### DESCRIPTION OF THE EMBODIMENTS

### First Embodiment

A three-dimensional structure forming device and a forming method according to one embodiment of the present disclosure will be described, but firstly, an overview of a three-dimensional structure formed by the forming device and the forming method of the present embodiment will be described.

(1) Overview of Three-Dimensional Structure

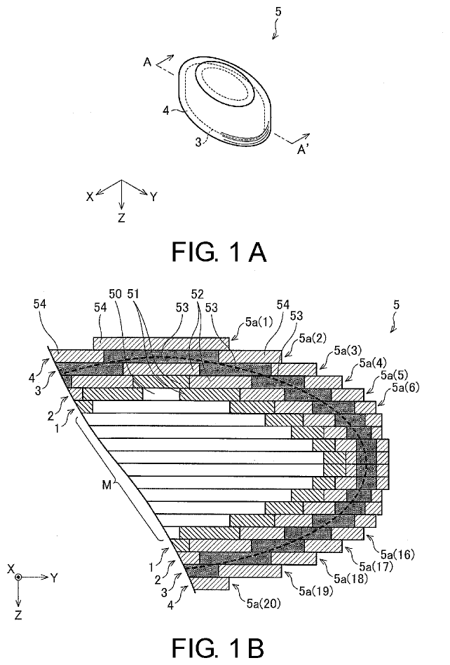

FIGS. 1A and 1B are diagrams showing a three-dimensional structure provided by the present embodiment. FIG. 1A is a diagram of an outer appearance of the three-dimensional structure, and FIG. 1B is a diagram showing a part of a cross sectional view taken along arrows, of the three-dimensional structure at a sectional line A-A′ in FIG. 1A.

A three-dimensional structure 5 shown in FIGS. 1A and 1B has a substantially cylindrical shape. The substantially cylindrical shape has substantially flat upper surface, lower surface, and side surface, has a curved surface from the side surface to the upper surface, furthermore has a curved surface from the side surface to the lower surface, and has an elliptical horizontal cross section. It should be noted that the shape of the three-dimensional structure is not limited to the one shown in FIGS. 1A and 1B, and for example, aside from a hexahedron described later, it may be any shape such as a sphere, a hollow structure, a ring structure, or a horseshoe shape.

The three-dimensional structure 5 has a second transparent layer 4, a colored layer 3 formed by ink containing colorant (coloring ink), a first transparent layer 2 (FIG. 1B) formed by transparent ink, a light reflecting layer 1 (FIG. 1B) formed by white ink or ink with light reflectivity, and a formed layer M (FIG. 1B) configuring a model main body portion formed in this order from its surface layer side (outer circumferential side) towards its inner side (center portion side). That is, in the three-dimensional structure 5, the formed layer M present at a center portion is coated by the light reflecting layer 1, the first transparent layer 2, the colored layer 3, and the second transparent layer 4 in this order.

It should be noted that in the present embodiment, the formed layer M and the light reflecting layer 1 are collectively regarded as a “model main body portion (object)”, and a surface of this model main body portion is considered as being covered by a “colored portion” including the first transparent layer 2, the colored layer 3, and the second transparent layer 4. However, the model main body portion (object) may be configured only by the formed layer M, or the model main body portion (object) may be configured only by the light reflecting layer 1 without providing the formed layer M. Further, the model main body portion may be provided with a hollow.

Further, the first transparent layer 2 may be regarded as being a part of the model main body portion (object). Further, in this case, the colored layer 3 and the second transparent layer 4 can be regarded as a colored portion.

Further, only the colored layer 3 may be regarded as the colored portion.

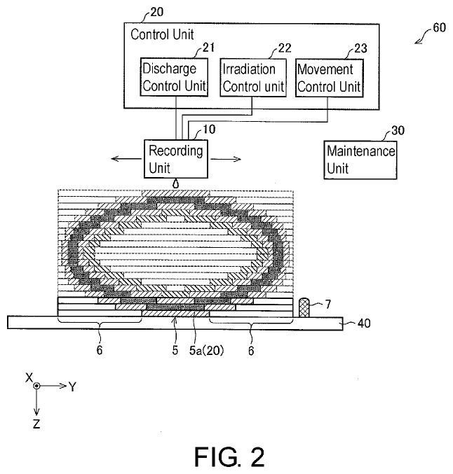

All of the formed layer M, the light reflecting layer 1, the first transparent layer 2, the colored layer 3, and the second transparent layer 4 are formed by discharging ink using an inkjet method by using a forming device 60 (FIG. 2) of the present embodiment to be described later, and depositing the ink.

As the ink, UV curing ink may be used. By using the UV curing ink, curing can be done within a short period of time, which brings advantages in that the layer lamination is easy and a three-dimensional structure can be manufactured within a shorter period of time. The UV curing ink contains a UV curing compound. As the UV curing compound, there is no limitation so long as it is a compound that is hardened upon ultraviolet ray irradiation. As the UV curing compound, for example, curing monomers and curing oligomers that are polymerized by the ultraviolet ray irradiation may be exemplified. Examples of the curing monomers include low viscosity acrylic monomer, vinyl ethers, oxetane-based monomer, or cyclic aliphatic epoxy monomer. Examples of the curing oligomers include acrylic oligomer.

It should be noted that the present disclosure is not limited to UV curing ink, and for example, thermoplastic ink can be used. The use of the thermoplastic ink allows curing of the heated ink as discharged by cooling to room temperature. At this occasion, measures for compulsory cooling may be taken to perform the curing within a shorter period of time.

The cross section of the three-dimensional structure 5 shown in FIG. 1B depicts a cross section along an YZ plane at a center position of the three-dimensional structure 5 in regards to an XYZ coordinate system shown in FIG. 1A.

As shown in FIG. 1B, the three-dimensional structure 5 is a three-dimensionally formed structure by a laminating scheme in which plural layers 5a(1), 5a(2), 5a(3), 5a(4), 5a(5), . . . are laminated using an inkjet method. It should be noted that the drawing shows the coordinate system that sets an axis along the laminating direction as a Z axis. In this coordinate system, each of the layers 5a(1), 5a(2), 5a(3), 5a(4), 5a(5), . . . extends along an XY axis plane, respectively. It should be noted that there is no specific limitation as to the total number of layers to be laminated.

The layers 5a(1), 5a(2), 5a(3), 5a(4), 5a(5), . . . that are obtained by slicing the three-dimensional structure 5 in which the light reflecting layer 1, the first transparent layer 2, the colored layer 3, and the second transparent layer 4 coat the formed layer M in this order from the formed layer M present at the center portion toward the surface layer side, as described earlier, into plural layers in a Z axis direction as in FIG. 1B each includes a part of the formed layer M (hereinbelow, a formed layer portion 50), a part of the light reflecting layer 1 (hereinbelow, light reflecting layer portion 51), a part of the first transparent layer 2 (hereinbelow, first transparent layer portion 52), a part of the colored layer 3 (hereinbelow, colored layer portion 53), or a part of the second transparent layer 4 (hereinbelow, second transparent layer portion 54), according to its laminated position.

Specifically, as shown in FIG. 1B, among the plural layers 5a(1), . . . , a layer 5a(20) at a lowest position and a layer 5a(1) at a highest position are formed as a layer including only the second transparent layer portion 54. Further, layers 5a(2) and 5a(19) in which the second transparent layer portion 54 is formed on an outer circumference of the colored layer portion 53 are arranged respectively on opposing sides (inner side) of these layers 5a(1) and 5a(20). Furthermore, on the inner side thereof, layers 5a(3) and 5a(18) in which the second transparent layer portion 54, the colored layer portion 53, and the first transparent layer portion 52 are formed in this order from an outer circumferential end toward the center are arranged. Furthermore, on the inner side thereof, layers 5a(4) and 5a(17) in which the second transparent layer portion 54, the colored layer portion 53, the first transparent layer portion 52, and the portion 51 of the light reflecting layer 1 are formed in this order from the outer circumferential end toward the center are arranged. Further, in an intermediate region intervened between them, layers (which are layers 5a(5), . . . 5a(16) in FIG. 1B) in which the second transparent layer portion 54, the colored layer portion 53, the first transparent layer portion 52, the light reflecting layer portion 51, and the formed layer portion 50 are formed in this order from the outer circumference side toward the center are arranged. Further, the laminate structure shown in FIG. 1B can be established by forming the layer 5a(20) at the lowest position to the layer 5a(1) at the highest position upward along the Z axis direction using the inkjet method in the laminating scheme. It should be noted that an arranged number of these various layers is not limited to the one shown in FIG. 1B. Further, the configuration of the respective layers 5a(1), . . . is not limited to those described above, so long as they can three-dimensionally form the three-dimensional structure 5 shown in FIG. 1A by the laminating scheme.

With the plural layers 5a(1), 5a(2), 5a(3), 5a(4), 5a(5), . . . being laminated in the Z axis direction as shown in FIG. 1B, the second transparent layer portions 54 in the respective layers 5a(1), 5a(2), 5a(3), 5a(4), 5a(5), . . . are substantially contiguous in an outermost circumferential surface direction of the three-dimensional structure 5 to form the second transparent layer 4. Further, the colored layer portions 53 of the respective layers 5a(2), 5a(3), 5a(4), 5a(5), . . . including the colored layer portions 53 are substantially contiguous in the outermost circumferential surface direction of the three-dimensional structure 5 to form the colored layer 3 (FIG. 1B shows a macroscopic view of a colored image surface by a broken line). Further, the first transparent layer portions 52 of the respective layers 5a(3), 5a(4), 5a(5), . . . including the first transparent layer portions 52 are substantially contiguous in the outermost circumferential surface direction of the three-dimensional structure 5 to form the first transparent layer 2. Further, the light reflecting layer portions 51 of the respective layers 5a(4), 5a(5), . . . including the light reflecting layer portions 51 are substantially contiguous in the outermost circumferential surface direction of the three-dimensional structure 5 to form the light reflecting layer 1. Further, the formed layer portions 50 of the respective layers 5a(5), 5a(6), . . . including the formed layer portions 50 are laminated to form the formed layer M.

(2) Forming Device

FIG. 2 is a diagram showing a primary configuration of a three-dimensional structure forming device (hereinbelow denoted as a forming device) according to the present embodiment. It should be noted that FIG. 2 also shows the half-finished three-dimensional structure 5.

The forming device 60 of the present embodiment is a device for forming the aforementioned three-dimensional structure 5 that includes the model main body portion (object) and the colored portion in which the surface thereof is colored as the laminate structure shown in FIG. 1B by the laminating scheme. As shown in FIG. 2, the forming device 60 of the present embodiment includes a recording unit 10, a control unit 20, a maintenance unit 30, and a stage 40.

(2-1) Recording Unit 10

The recording unit 10 is a unit for discharging the aforementioned ink using the inkjet method and curing the discharged ink so as to form the aforementioned three-dimensional structure 5 by the laminating scheme.

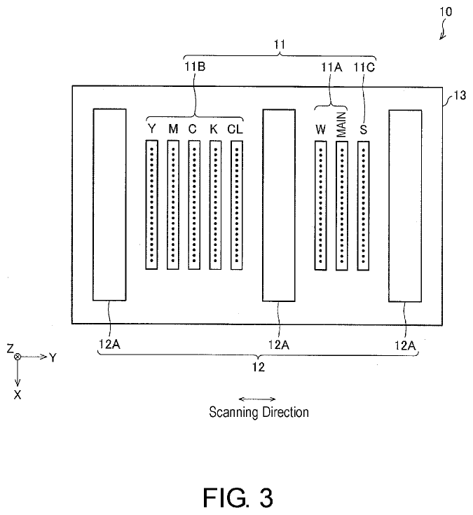

FIG. 3 shows a specific configuration of the recording unit 10, and shows an ink discharging surface (lower surface) of the recording unit 10. As shown in FIG. 3, the recording unit 10 includes a carriage 13, an inkjet head 11, and an UV irradiating unit 12.

(2-1-1) Carriage 13

The carriage 13 can move in a reciprocating manner along the Y axis, and has the inkjet head 11 and the UV irradiating unit 12 mounted thereon. The movement of the carriage 13 is controlled by the control unit 20 to be described later.

(2-1-2) Inkjet Head 11

The inkjet head 11 discharges the aforementioned ink by using the inkjet method. Specifically, as shown in FIG. 3, the inkjet head 11 includes a first inkjet head nozzle unit 11A, a second inkjet head nozzle unit 11B, and a third inkjet head nozzle unit 11C.

The first inkjet head nozzle unit 11A discharges ink being a forming material for forming the model main body portion (object) (the formed layer portions 50 and the light reflecting layer portions 51 shown in FIG. 1B), which is a part of the three-dimensional structure 5 shown in FIG. 1B. In the present embodiment, as the forming material, forming ink for forming the formed layer M (formed layer portions 50) and white ink for forming the light reflecting layer 1 (light reflecting layer portions 51) are used. Accordingly, the first inkjet head nozzle unit 11A includes a forming ink nozzle row MAIN for discharging the forming ink and a white ink nozzle row W for discharging the white ink. As the forming ink, conventionally known forming ink can be used, but the white ink to be discharged from the white ink nozzle row W, or transparent ink to be discharged from a transparent ink nozzle row CL to be described later may be used.

The second inkjet head nozzle unit 11B discharges ink being colorant materials for forming the colored portion being a part of the three-dimensional structure 5 shown in FIG. 1B (first transparent layer portions 52, colored layer portions 53, and second transparent layer portions 54 shown in FIG. 1B). In the present embodiment, yellow ink, magenta ink, cyan ink, black ink, and transparent ink are used as the colorant materials. Accordingly, the second inkjet head nozzle unit 11B is provided with a yellow ink nozzle row Y for discharging the yellow ink, a magenta ink nozzle row M for discharging the magenta ink, a cyan ink nozzle row C for discharging the cyan ink, a black ink nozzle row K for discharging the black ink, and a transparent ink nozzle row CL for discharging the transparent ink.

The third inkjet head nozzle unit 11C discharges ink being a supporting material that is not configured in the aforementioned three-dimensional structure. Accordingly, the third inkjet head nozzle unit 11C is provided with a supporting material ink nozzle row S for discharging light-curing type of supporting material ink.

Here, the supporting material is not configured to be in the three-dimensional structure, but it is for supporting or retaining the three-dimensional structure in a forming process of the three-dimensional structure. As an example of such a support, the three-dimensional structure 5 shown in FIGS. 1A and 1B has a shape of a lower half portion in which a diameter of the layers extends gradually along a laminating direction. For example, when seeing a relationship of the layer 5a(20) at the lowest position and the layer 5a(19) that is laminated thereon shown in FIG. 1B, the layer 5a(19) being an upper layer has a larger size in an XY axis plane direction, and its outer circumferential end is structured to protrude out from an outer circumference end of the layer 5a(20) being a lower layer.

In forming this structure by using the inkjet method and depositing the ink, if only the three-dimensional structure is attempted to be formed, the protruded portion will not have any lower layer that supports the portion located directly thereunder, and the ink will fall without being able to form the protruded portion. Thus, the supporting material functions as a support therefor. In short, in the scheme that laminates layers by further depositing ink on top of an ink deposit formed by the deposition of the ink, in the event where no deposit is placed on the lower side, the supporting material is used to deposit the ink for configuring the three-dimensional structure on the supporting material. This forming scheme using the supporting material may be used, aside from the case of forming the protruded portion, in cases of forming an arch-shaped structure.

As another function, the supporting material further has a damming function for holding back the ink not to undesirably spreading further outward upon depositing the ink on the outer circumferential ends of the respective layers 5a(1), . . . . Due to this, even in a case of forming a layer that does not have the protruded portion, the supporting material is formed on the outer circumference of the layer upon laminating the layer.

The supporting material is removed in a post-processing. As the supporting material ink, conventionally known ones such as water-soluble UV curing resin and the like may be used.

A plurality of nozzle rows provided in the first inkjet head nozzle unit 11A, a plurality of nozzle rows provided in the second inkjet head nozzle unit 11B, and a nozzle row provided in the third inkjet head nozzle unit 11C are arranged along a scanning direction of the recording unit 10 (Y axis direction). That is, as shown in FIG. 3, the yellow ink nozzle row Y, the magenta ink nozzle row M, the cyan ink nozzle row C, the black ink nozzle row K, the transparent ink nozzle row CL, the white ink nozzle row W, the forming ink nozzle row MAIN, and the supporting material ink nozzle row S are arranged in this order along the Y axis direction.

It should be noted that each of the nozzle rows as shown in FIG. 3 has a plurality of nozzle holes arranged along the X axis direction. The ink may be discharged only from several nozzle holes among the plurality of nozzle holes. Further, the arrangement order and numbers of the nozzle rows are also not limited to those shown in FIG. 3.

Since the recording unit 10 has the respective ones of the pluralities of nozzle rows on the carriage 13, the UV curing ink can be discharged (dripped) in the Z-axis direction from the plurality of nozzle rows upon moving in the Y direction accompanying the movement of the carriage 13.

(2-1-3) UV Irradiating Unit 12

The UV irradiating unit 12 includes a plurality of irradiators 12A each of which has a light source for curing ink, and is mounted on the carriage 13. Specifically, the UV irradiating unit 12 includes three irradiators 12A arranged along the Y-axis direction. The carriage 13 has the irradiator 12A, the third inkjet head nozzle unit 11C, the first inkjet head nozzle unit 11A, the irradiator 12A, the second inkjet head nozzle unit 11B, and the irradiator 12A in this order along the Y-axis direction from a right side toward a left side of a sheet surface of FIG. 3. Accordingly, since all of the nozzle rows are arranged along the Y direction, all types of ink configuring one layer can be discharged by one movement in the Y direction, and at the same time, since the ultraviolet irradiation is performed simultaneously as the discharging, the discharge and curing can be performed at the same timing.

(2-2) Control Unit 20

The control unit 20 includes a discharge control unit 21, an irradiation control unit 22, and a movement control unit 23 as shown in FIG. 2.

The discharge control unit 21 is for controlling the ink discharge from the first inkjet head nozzle unit 11A, the second inkjet head nozzle unit 11B, and the third inkjet head nozzle unit 11C of the recording unit 10. By controlling the ink discharge, discharge timing, discharge droplet volume, discharge force and the like can be adjusted optimally. The discharge timing is adjusted by controlling voltage application timing onto the inkjet head 11 from a power source that is not shown, the discharge droplet volume and the discharge force are adjusted by controlling voltage application amount onto a nozzle for discharging the ink in the inkjet head 11.

The discharge control unit 21 is provided with a memory unit that is not shown, and the memory unit stores model data of the three-dimensional structure (including input data for forming the colored portion) and the like. The model data of the three-dimensional structure refers to multilayer pattern data in which, after having formed data of design and mechanisms of outer and inner appearances of an end product by 3D CAD, the aforementioned data is sliced such that thin plates are overlapped one another by a computer. It should be noted that the model data of the three-dimensional structure may be acquired from the outside of the discharge control unit 21, or may be stored in advance in the memory, or may be generated by the discharge control unit 21 based on information acquired from the outside of the discharge control unit 21. Further, in the present embodiment, the pattern data is regarded to include model data of the supporting material.

The discharge control unit 21 controls the ink discharge from the nozzles of the nozzle rows in the first inkjet head nozzle unit 11A, the second inkjet head nozzle unit 11B, and the third inkjet head nozzle unit 11C of the inkjet head 11, the discharging amount thereof, and the discharging force thereof based on this pattern data.

Further, what is characteristic in the present embodiment is that the discharge control unit 21 controls the inkjet head 11 so that the ink is preliminarily discharged from all of the nozzles of all of the nozzle rows of the first inkjet head nozzle unit 11A, the second inkjet head nozzle unit 11B, and the third inkjet head nozzle unit 11C based on data that is different from the pattern data, at outside of the region where the three-dimensional structure is to be formed.

The data for preliminarily discharging the ink (hereinbelow, preliminary discharge data) includes information related to timing to preliminarily discharge the ink, discharge droplet volume, and discharging force and the like.

The preliminary discharge data may be acquired from the outside of the discharge control unit 21, may be stored in advance in the memory unit, or may be generated by the discharge control unit 21 based on the information acquired from the outside of the discharge control unit 21.

The discharge control unit 21 generates one combined data that the pattern data and the preliminary discharge data are combined, and controls the ink discharge from the first inkjet head nozzle unit 11A, the second inkjet head nozzle unit 11B, and the third inkjet head nozzle unit 11C based on this combined data.

The irradiation control unit 22 is for controlling the UV irradiation by the UV irradiating units 12 of the recording unit 10.

The movement control unit 23 is for controlling movement (scan) by the carriage 13 of the recording unit 10.

(2-3) Maintenance Unit 30

The maintenance unit 30 is for performing maintenance of the inkjet head 11 of the recording unit 10. Specifically, the maintenance unit 30 performs at least one of wiping, capping, and ink flushing from respective nozzle rows on the nozzle discharging surfaces of the first inkjet head nozzle unit 11A, the second inkjet head nozzle unit 11B, and the third inkjet head nozzle unit 11C provided in the inkjet head 11. It should be noted that a maintenance mechanism provided in an ink discharging device that uses a conventionally known inkjet method can be employed.

As shown in FIG. 2, the maintenance unit 30 is provided at a position separated from a region where the recording unit 10 forms the three-dimensional structure. The recording unit 10 moves to the position by receiving the control by the movement control unit 23 during when the three-dimensional structure is not being formed to receive maintenance from the maintenance unit 30. The maintenance unit 30 is preferably provided on a scanning passage of the recording unit 10 in the Y-axis direction. In the present embodiment, the maintenance unit 30 is provided so as to be present at a destination where the recording unit 10 reaches by moving in a positive direction of the Y-axis direction.

The recording unit 10 that has received the maintenance by the maintenance unit 30 moves (scans) in a negative direction of the Y-axis direction, and discharges the ink from the predetermined nozzles in the predetermined nozzle row at the predetermined timing by receiving the control by the discharge control unit 21 while it passes over the stage 40.

In the present embodiment, one layer 5a(1), . . . as shown in FIG. 1B can be formed while performing one scan by the recording unit 10, that is, by the recording unit performing one scan in a negative direction of the Y-axis direction from the position where it has received maintenance by the maintenance unit 30.

In the present embodiment, the maintenance unit 30 performs maintenance on the recording unit 10 before the recording unit 10 starts to form the three-dimensional structure, that is, before forming the layer 5a(20) being at the lowest position. It should be noted that the maintenance by the maintenance unit 30 is not limited to this occasion. For example, it may be performed when a power switch of the forming device 60 is turned on.

(2-4) Stage 40

The stage 40 is a plate-shaped stage for depositing the ink discharged from the inkjet head 11 of the recording unit 10. The three-dimensional structure 5 is formed on the stage 40 as shown in FIG. 2, and the ink discharged preliminarily as aforementioned is deposited.

The lower surface of the recording unit 10 is arranged in an opposed manner to an upper surface of the stage 40, and as aforementioned, plural layers (a total of 20 layers in the present embodiment) can be laminated with the layer 5a(20) extending along the upper surface of the stage 40 as the layer on the lowest position, by discharging the ink during the movement by reciprocatingly moving the recording unit 10 in the Y-axis direction.

It should be noted that in the present embodiment, an embodiment in which the position of the stage 40 is fixed, and only the recording unit 10 moves will be described, however, the present disclosure is not limited to this, and relative positions of the recording unit 10 and the stage 40 simply need to change in a predetermined direction, and the recording unit 10 may move in the predetermined direction in an XYZ coordinate system, or the stage 40 may move in the predetermined direction in the XYZ coordinate system, and whichever may perform the movement.

(3) Forming Method (Operation of Forming Device)

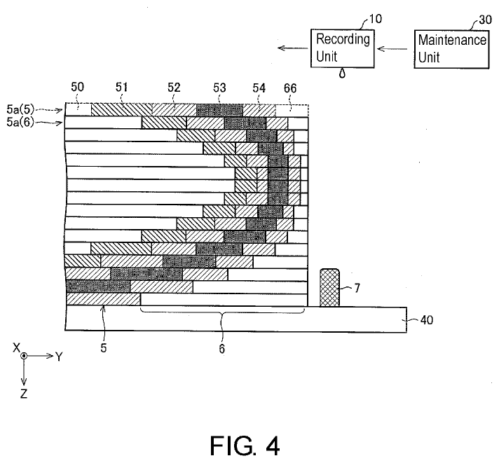

Hereinbelow, together with the operation of the forming device 60, the forming method of the three-dimensional structure 5 of the present embodiment will be described. FIG. 4 is a diagram showing a part of FIG. 2 in an enlarged manner.

A characteristic feature of the forming method of the present embodiment lies in including a preliminary discharging step that preliminarily discharges the ink for use in the layer formation from the recording unit 10 while being between the position where the recording unit 10 has received the maintenance by the maintenance unit 30 and the position where the recording unit 10 starts the formation of the layers 5a(20), . . . configuring the three-dimensional structure. “Preliminarily discharge” means that the ink for forming the layers 5a(20), . . . is discharged at a position (region) where the layers 5a(20), . . . are not to be formed, prior to forming the layers 5a(20), . . .

As to the forming method of the present embodiment, description will be given by using FIG. 4 showing a process by which the recording head 10 forms the layer 5a(5) that is at a fifth layer from the top as shown in FIG. 1B.

FIG. 4 shows a stage of the process where the recording unit 10 starts one scan along the negative direction of the Y-axis direction from the position to receive the maintenance, and is about to further laminate the layer 5a(5) on the layer 5a(6). In the one scan performed for forming the layer 5a(5), the preliminary discharging step is performed before starting to form the layer 5a(5), more specifically, before forming one portion 66 of the supporting material that is formed first of all within the layer 5a(5).

In the preliminary discharging step, the ink is discharged from all of the nozzles in the respective ink rows of the first inkjet head nozzle unit 11A, the second inkjet head nozzle unit 11B, and the third inkjet head nozzle unit 11C in the recording unit 10. The respective types of ink as discharged strike onto the stage 40 (preliminarily discharged deposit 7 in FIG. 4) on the positive direction side of the Y-axis direction from the layer 5a(5) (more accurately, the region where the layer 5a(5) is to be formed).

After the preliminary discharge, the scanning position of the recording unit 10 further progresses, and a part of the supporting material is laminated at a position corresponding to the outer circumference of the layer 5a(5) on top of the one portion 66 of the supporting material formed on the outer circumference of the formed layer 5a(6), and thereafter the second transparent layer portion 54, the colored layer portion 53, the first transparent layer portion 52, the light reflecting layer portion 51, and the formed layer portion 50 are formed along the negative direction of the Y-axis direction, and one layer 5a(5) is completed by forming the second transparent layer portion 54 configuring the end on the most negative side of the Y-axis direction within the layer 5a(5). Then, subsequently, one portion 66 of the supporting material is formed in the outer circumference of the layer 5a(5), and the one scan is completed.

In the present embodiment, the recording unit 10 that has completed one layer 5a(5) and has finished the one scan in the negative side of the Y-axis direction moves in the positive direction of the Y-axis direction and performs a recording step of laminating the layer 5a(4) (FIG. 1B) that is not shown on the layer 5a(5).

Further, when the layer 5a(4) and the formation of the one portion 66 of the supporting material on the outer circumference thereof are completed, the recording unit 10 performs the preliminary discharging step similar to the one described earlier prior to the start of the formation of the layer 5a(3) (more accurately, prior to the start of the formation of the one portion 66 of the supporting material on the outer circumference of the layer 5a(3)), and starts the formation of the layer 5a(3) (more accurately, the formation of the one portion 66 of the supporting material on the outer circumference of the layer 5a(3)) after preliminarily discharging the ink.

It should be noted that as the lamination progresses, the recording unit 10 moves along the negative direction of the Z-axis direction at an appropriate timing.

In the present embodiment, the preliminary discharging step is performed each time while the recording unit scans from the position to receive the maintenance to the position where the layer formation is started, or once after plural layers are formed, and the preliminarily discharged deposit 7 in which the ink discharged in the preliminary discharging step has struck and deposited is formed on the stage 40 as the plural layers 5a(20), . . . are laminated.

It should be noted that in FIG. 4, the preliminarily discharged deposit 7 is present as one collective solid body, however, the present disclosure is not limited to this and it may be dispersed; however, in view of the fact that it is to be removed from the stage 40 in the final stage, it is preferable that the deposit is deposited collectively as one solid body, or is gathered together for easier removal.

Further, in the present embodiment, the ink that has been preliminarily discharged is deposited on the stage 40, however, a hole may be provided outside the stage 40 or on the stage 40, and the ink may be dropped beneath the stage 40 without having it strike onto the stage 40.

The discharge timing for preliminarily discharging the ink in the preliminary discharging step can for example be determined according to the relative positions of the recording unit 10 (more specifically, each inkjet head nozzle unit) and the stage 40. For example, the position of the recording unit 10 may be sensed, and the ink may be discharged from all of the nozzles when the recording unit 10 is present above a region of the preliminarily discharged deposit 7 in FIG. 4.

Alternatively, the control unit 20 (FIG. 2) may predeterminedly have a timing chart, and the ink may be discharged from all of the nozzles when a predetermined time has elapsed from when the scan has been started. This embodiment enables a size of the forming device on the whole to become smaller than in the embodiment that senses the relative positions, since parts related to sensing does not need to be provided.

The discharging condition of the ink to be discharged for the layer formation can be made to match the predetermined condition by preliminarily discharging the ink in the preliminary discharging step, and the effect that a desired layer can be formed can be achieved.

When even a slightest time is present while the recording unit 10 is between the position to receive the maintenance and the starting position of the layer formation, ink solvent is evaporated from the nozzles of the recording unit 10 and undesirable conditions such as an increase in viscosity of the ink occurs, and due to this, the ink may not be discharged under the predetermined condition when the layer formation is started in this circumstance. Specifically, the ink discharging droplet volume, the ink discharging direction, the ink discharging force and the like may not satisfy the predetermined condition. Contrary to this, in the forming method of the present embodiment, the ink discharging condition is managed by preliminarily discharging the ink prior to the layer formation, and the accurate layer formation under the predetermined condition is thereby enabled.

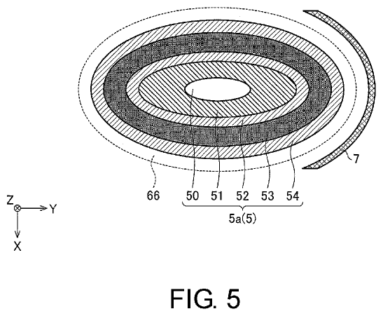

Further, it is preferable to manage the ink discharging condition just before starting the layer formation. This is because the time that is present again after the managing would be a cause of deviations in the discharging condition. Thus, the position to preliminarily discharge the ink is preferably a position that is close as possible to the supporting material 6 (one portion 66 of the supporting material). However, since the three-dimensional structure 5 provided in the present embodiment as shown in FIG. 1 has its side surface bulged outward, it is preferable to preliminarily discharge the ink outside of the one portion of the supporting material formed on the outer circumference of the layer configuring the portion that is most bulged out within the side surface as shown in FIG. 4, and in the vicinity of the one portion of the supporting material. Here, FIG. 5 shows an upper surface diagram of the layer 5a(5) formed by undergoing the aforementioned respective steps, and for the sake of convenience of explanation, the one portion 66 of the supporting material formed on the outer circumference of the layer 5a(5) and the preliminarily discharged deposit 7 of the ink that has been preliminarily discharged are also depicted. As shown in FIG. 5, the ink that is preliminarily discharged is deposited in the vicinity of the one portion 66 of the supporting material formed on the outer circumference of the layer 5a(5) on the positive direction side along the Y axis.

It should be noted that all of the discharging droplet volume, the discharging direction, and the discharging force of the ink that is preliminarily discharged are controlled by the discharge control unit 21 of the control unit 20.

Here, in the present embodiment, the embodiment in which the ink is preliminarily discharged from all of the nozzles in each ink row of the first inkjet head nozzle unit 11A, the second inkjet head nozzle unit 11B, and the third inkjet head nozzle unit 11C of the recording unit 10 in the preliminary discharging step is explained. However, the present disclosure is not limited to this, and the ink may be preliminarily discharged from only some of the nozzle rows.

Further, in the case of preliminarily discharging the ink from only some of the nozzle rows as above, it is preferable to preliminarily discharge the ink configuring the colored portion, specifically, preliminarily discharge the ink from the nozzles of the nozzle rows configured to be in the second inkjet head nozzle unit 11B. The reason of this is because a color tone to be exhibited on the three-dimensional structure 5 of the present embodiment is determined by the colored portion. Since the predetermined color tone cannot be exhibited if the ink discharging condition configuring the colored portion is deviated from the predetermined discharging condition, the nozzles of the nozzle rows formed in the second inkjet head nozzle unit 11B for discharging the ink configuring the colored portion preferably performs preliminary discharge of the ink at the least.

Here, the discharging amount per unit area for the ink that is preliminarily discharged is configured to be less than the discharging amount per unit area of the ink to be discharged for forming each of the layers 5a(1), . . . Since the ink that is preliminarily discharged is in fact ink that is wastefully consumed, wasteful consumption can be suppressed by reducing the consumption amount thereof as much as possible. For example, the discharging amount per unit area of the ink that is preliminarily discharged is 80% or lower, and preferably 50% or lower than the discharging amount per unit area of the ink to be discharged for forming each of the layers 5a(1), . . . .

It should be noted that in the preliminary discharging step described using FIG. 4, the maintenance by the maintenance unit 30 is not conducted before the preliminary discharge. The maintenance is not mandatorily conducted. The essence of the present disclosure lies in preliminarily discharging the ink while being between the position for the maintenance unit 30 and the position to start the layer formation, and the maintenance does not need to be conducted just before each of the preliminary discharge of the ink.

It should be noted that the control unit of the present embodiment (especially, the discharge control unit 21, the irradiation control unit 22, and the movement control unit 23) may be actualized by a logic circuit (hardware) formed in an integrated circuit (IC chip) and the like, or may be actualized by software using a CPU (Central Processing Unit). In the latter case, the forming device 60 includes the CPU that executes instructions of a program being the software for actualizing the respective functions, a ROM (Read Only Memory) or a memory device (which are collectively termed a “recording medium”) in which the program and various types of data are recorded in a computer (or CPU) readable manner, a RAM (Random Access Memory) that expands the program, and the like. Further, the purpose of the present disclosure is achieved by the computer (or CPU) reading the program from the recording medium and executing the same. As the recording medium, a “non-volatile, tangible medium”, such as a tape, disk, card, semiconductor memory, programmable logic circuit, and the like may be used. Further, the program may be supplied to the computer through an arbitrary transfer medium (communication network, broadcast waves, and the like) that can transfer the program. It should be noted that in the present disclosure, the program may be provided in a form of data signals embedded in transfer waves, which are implemented by electronic transfer.

(4) Other Features of Three-Dimensional Structure

As to the three-dimensional structure 5, since only the outline thereof has been described, other configurations of the three-dimensional structure 5 will be described hereinbelow with reference to FIG. 1B.

A thickness (height) of each layer 5a(1), . . . in a Z direction can suitably be set by the number of lamination, and the like. Since the lamination is performed in the present embodiment using the inkjet method, the thickness of the layers 5a(1), . . . in the Z direction that can be provided by this lamination method can be considered. The thickness of one layer 5a(1), . . . in the Z direction is a value that is primarily suitable for multicolor formation of the colored layer 3 by a subtractive color mixing, and within a range of 5 μm to 50 μm. Further, in the present embodiment, since the UV curing ink is formed into layers by the inkjet method, the thickness of each layer 5a(1), . . . can be 5 μm to 20 μm depending on a size of the ink droplet, and its preferable range is 10 μm to 25 μm.

Hereinbelow, the light reflecting layer 1 (light reflecting layer portion 51), the first transparent layer 2 (first transparent layer portion 52), the colored layer 3 (colored layer portion 53), and the second transparent layer 4 (second transparent layer portion 54) will respectively be described.

Light Reflecting Layer 1 (Light Reflecting Layer Portion 51)

The light reflecting layer 1 (light reflecting layer portion 51) is a layer having light reflectivity, and has light reflectivity by which light in entire visible light range can be reflected at least on a surface of the light reflecting layer 1 on a colored layer side.

The light reflecting layer 1 (light reflecting layer portion 51) can be formed of ink containing white pigments (white ink). By forming the same from the white ink, the light that has entered from a side of the surface layer of the three-dimensional structure can satisfactorily be reflected in the light reflecting layer 1, and the coloring by the subtractive color mixing can thereby be realized. It should be noted that other than being white, it may be a layer formed of ink having light reflectivity, such as ink containing metal powder.

The thickness of the light reflecting layer 1 may be 5 μm to 20 μm at minimum. The thickness of the light reflecting layer 1 termed herein is identical to a width from a side of the outer circumferential end of the light reflecting layer portion 51 contained in the layers 5a(4), . . . in a center-side direction. It should be noted that the present disclosure is not limited to this numerical range.

Configuration of First Transparent layer 2 (First Transparent Layer Portion 52)

The first transparent layer 2 (first transparent layer portion 52) is formed of the transparent ink.

Here, the transparent ink may be any ink so long as a transparent layer with light permeability of 50% or more per unit thickness can be formed. When the light permeability per unit thickness is below 50%, the permeation of light is undesirably inhibited, and the desired color tone cannot be exhibited by the object using the subtractive color mixing, which is not preferable. Further, ink of which light permeability per unit thickness of the transparent layer is 80% or more is preferably used, and more preferably, ink of which light permeability per unit thickness of the transparent layer is 90% or more is used.

By providing the first transparent layer 2 (first transparent layer portion 52) between the light reflecting layer 1 (light reflecting layer portion 51) and the colored layer 3 (colored layer portion 53), the coloring ink forming the colored layer 3 and the ink forming the light reflecting layer 1 can be prevented from being mixed. As such, even if the coloring ink forming the colored layer is mixed with the transparent ink forming the first transparent layer, the color of the colored layer 3 will not be lost; thus, no undesired change in the color tone will be generated. Accordingly, an object exhibiting the desired color tone (decoration) in the colored layer 3 can be provided.

The thickness of the first transparent layer 2 may be 5 μm to 20 μm. The thickness of the first transparent layer 2 termed herein is identical to a width from a side of the outer circumferential end of the first transparent layer portion 52 contained in the layers 5a(3), . . . in the center-side direction. It should be noted that, the present disclosure is not limited to this numerical range.

### Colored Layer 3 (Colored Layer Portion 53)

The ink used in the formation of the colored layer 3 (colored layer portion 53) includes coloring ink containing colorant.

As the coloring ink, yellow (Y), magenta (M) and cyan (C), black (K), and ink of the respective light colors are included, however, it is not limited hereto, and red (R), green (G), blue (B), orange (Or), and the like may be added. Further, it is also possible to use metallic, pearly, or fluorescent color. One type or plural types of the coloring ink are used to express the desired color tone.

Meanwhile, the amount of the coloring ink used for forming the colored layer 3 (colored layer portion 53) varies depending on the desired color tone (that is intended to be exhibited). Due to this, in a case of low concentration and light color tone, an ink-filling density of the colored layer 3 (colored layer portion 53) cannot satisfy a predetermined ink-filling density by the mere use of the coloring ink, and there may be cases where variation is formed in the height in the Z direction, or a dent lacking the coloring ink is formed along X and Y directions. Undesirable surface roughness is generated in all of the cases on the object formed by the laminating scheme as in the present embodiment, which is not preferable. Especially, in a vertical formed surface in the vicinity of a center of the laminated structure shown in FIG. 1B, there are cases where a gap space worth four droplets may be formed in a minimum case in the ink formation by an error diffusion method, when one cross section of the colored layer 3 has the filling density of a total of four droplets, being two droplets each vertically and horizontally, and the number of the coloring ink is four droplets at maximum (maximum concentration) and zero at minimum (no concentration, that is, white color), whereby quality is significantly degraded in terms of both shape and color tone.

Thus, in the present embodiment, for portions where the ink-filling density of the colored layer 3 (colored layer portion 53) does not satisfy the predetermined ink-filling density by the mere use of the coloring ink, an ink-filling density supplementation is performed for the colored layer 3 (colored layer portion 53) by supplemental ink. That is, the colored layer 3 (colored layer portion 53) is formed so that a combined density (number of ink droplets) of the coloring ink and the supplemental ink comes to be constant. Due to this, the generation of the dent as described above can be prevented, and the shape of the three-dimensional structure 5 can be formed elaborately.

Since the discharging amount of the coloring ink and the striking positions of the respective ink configuring the coloring ink are known in advance, supplementing amount and supplementing position (striking position) of the supplemental ink can be determined by taking them into consideration. This determination can be made by the inkjet head, the control unit 20 (FIG. 2), or another controlling unit.

Further, by supplementing the ink-filling density by the supplemental ink, the surface formed by the colored layer 3 becomes flat, and glossiness can be provided thereon.

The supplemental ink may be any ink that does not have any adverse effect on the color tone that is to be exhibited by the colored layer 3 (colored layer portion 53); and as an example thereof, the transparent ink that is used in the first transparent layer 2 (first transparent layer portion 52) and the second transparent layer 4 (second transparent layer portion 54) may be employed.

The thickness of the colored layer 3 may be 5 μm to 20 μm, for example. The thickness of the colored layer 3 termed herein is identical to a width from a side of the outer circumferential end of the colored layer portion 53 contained in each of the layers 5a(2), . . . in the center-side direction.

It should be noted that although the description is given in the present embodiment based on the colored layer 3, the present disclosure is not limited to the colored layer, and there is no specific limitation so long as it is a decoration layer.

Configuration of Second Transparent layer 4 (Second Transparent Layer Portion 54)

The second transparent layer 4 (second transparent layer portion 54) is formed by using the transparent ink as described in connection to the first transparent layer 2 (first transparent layer portion 52). The second transparent layer 4 and the first transparent layer 2 may be formed by using the same type of transparent ink, or may be formed by using different types of transparent ink.

The thickness of the second transparent layer 4 may be 10 μm or more, for example, and an upper limit value thereof can suitably be changed according to the external size of the three-dimensional structure 5. The thickness of the second transparent layer 4 termed herein is identical to a width of the second transparent layer portion 54 from a side of the outer circumferential end of each of the layers 5a(1), . . . , including the second transparent layer portion 54, in the center-side direction.

The second transparent layer 4 not only has a function as a protective layer for the colored layer 3, but also provides a superior effect of enabling the three-dimensional structure to be produced elaborately in the present disclosure (the present embodiment) that employs the laminating scheme. That is, in a case where the colored layer 3 forms the outermost layer of the three-dimensional structure 5, that is, in a case where the colored layer portion 53 is positioned at the outermost end within the layer including the colored layer portion 53, there is a risk that the colored layer 3 (colored layer portion 53) may not be formed accurately. However, since the colored layer 3 (colored layer portion 53) is formed accurately by the second transparent layer 4 (second transparent layer portion 54) being formed on the outermost layer of the three-dimensional structure 5 as in the present embodiment, contribution can be made to exhibiting the desired color tone by the second transparent layer 4 (second transparent layer portion 54).

Further, in the case where the colored layer 3 forms the outermost layer of the three-dimensional structure 5, the colored layer 3 will be exposed, whereby decoloration by friction and color fading by ultraviolet ray are generated more frequently. However, by forming the second transparent layer 4 (second transparent layer portion 54) on the outermost layer of the three-dimensional structure 5 as in the present embodiment, such decoloration and color fading can be prevented.

### Second Embodiment

In the above first embodiment, an embodiment in which the ink is preliminarily discharged on the outside of the supporting material had been described, however, the present disclosure is not limited to this. Thus, in the present embodiment, another example of the striking position of the ink that is preliminarily discharged will be exemplified, and another embodiment of the forming method according to the present disclosure will be described. It should be noted that for the sake of convenience of explanation, members having the same function as the members described in the first embodiment will be given the same reference signs, and the description thereof will be omitted.

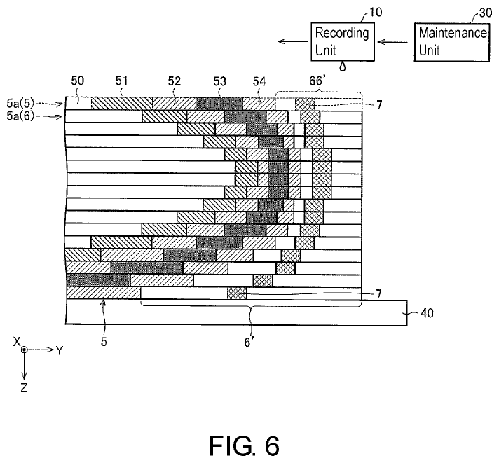

FIG. 6 is a diagram for explaining the forming method of the present embodiment, and corresponds to FIG. 4 of the first embodiment.

A difference between the present embodiment and the first embodiment is in a forming portion of the preliminarily discharged deposit 7. As shown in FIG. 6, the forming method of the present embodiment differs from the first embodiment in that the preliminarily discharged deposit 7 is formed within a supporting material 6′.

In short, in the present embodiment, the preliminary discharging step as described in the first embodiment is performed in a step of forming one portion 66′ of the supporting material to be formed on an outer circumference of each layer. Due to this, as shown in FIG. 6, the preliminarily discharged deposit 7 is formed in the one portion 66′ of the supporting material. The forming position of the preliminarily discharged deposit 7 can be controlled by the control unit 20.

As in the present embodiment, by forming the preliminarily discharged deposit 7 within the supporting material 6′, the preliminarily discharged deposit 7 can be removed altogether upon removing the supporting material in the end; whereby a process to independently remove the preliminarily discharged deposit 7 as in the first embodiment is not necessary, and the forming process can be simplified.

It should be noted that in FIG. 6, the forming positions of the preliminarily discharged deposit 7 included in the respective layers are located at different distances from the ends of the respective layers, however, the preliminarily discharged deposit 7 may be formed at a location of a certain distance from the ends of the respective layers. That is, the preliminarily discharged deposit 7 may be aligned in one line along the laminating direction within the supporting material 6′.

[Variation 1]

It should be noted that in the aforementioned first and second embodiments, the embodiment in which the preliminary discharging step is performed each time the recording unit 10 moves back and forth, however, the present disclosure is not limited to this; and the ink may be preliminarily discharged each time the recording unit 10 forms a layer, that is, for each scan regardless of being an outgoing pass or an incoming pass, during a period from when the scan is started until when the layer formation is started (starting to form a part of the supporting material).

[Variation 2]

It should be noted that in the aforementioned first and second embodiments, the maintenance unit 30 is provided only on a side of the Y-axis positive direction on the Y axis from the region where the three-dimensional structure 5 is formed, however, the maintenance unit 30 may also be provided on a side of the Y-axis negative direction from the region where the three-dimensional structure 5 is formed (which is the left end portion with respect to the sheet surface in FIG. 2). Further, the maintenance may be performed before starting the scan, regardless of the recording unit 10 being in the outgoing pass or the incoming pass.

[Supplemental Information]

According to the present disclosure, one embodiment of the three-dimensional structure forming device is characteristic in being a three-dimensional structure forming device 60 for forming the three-dimensional structure5 including the model main body portion and the colored portion that colors a surface thereof, by laminating layers 5a(1), 5a(2), . . . formed by depositing ink, and the three-dimensional structure forming device 60 includes: the recording unit 10 that discharges the ink during at least one scan to form one of the layers 5a(1), 5a(2), . . . ; the maintenance unit 30 that performs maintenance on the recording unit 10; and the control unit 20 that controls the recording unit 10, wherein the control unit 20 controls the recording unit 10 to preliminarily discharge the ink while being between a position to receive the maintenance by the maintenance unit 30 and the position to start the layer formation.

According to the above configuration, the ink discharge can be performed under a predetermined discharging condition from the start of the formation of the layers 5a(1), 5a(2), . . . , and the forming device that can form the three-dimensional structure 5 highly accurately can be provided.

Specifically, according to the above configuration, the recording unit 10 is configured to preliminarily discharge the ink while being between the position to receive the maintenance and the position to start layer formation. Due to this, the ink discharging condition of the recording unit can be brought to a state suitable for the layer formation just before the layer formation.

For example, when there is a period during which the ink is not discharged before starting the ink discharge for the layer formation, there are cases where the ink discharging condition of the recording unit 10 changes in an undesirable manner, such as by nozzle holes for discharging the ink of the recording unit 10 becoming dry. However, according to the above configuration, since the ink is preliminarily discharged before the layer formation, this preliminary ink discharge can optimize the ink discharging condition of the recording unit 10. Due to this, the layer formation can be started under the optimal ink discharging condition.

Thus, according to the forming device 60, the layers can accurately be formed.

It should be noted that the same applies to a period from just after the recording unit 10 has received maintenance (for example, wiping, capping, and flushing) by the maintenance unit 30 to the start of the layer formation. That is, even if the recording unit 10 comes to be in a satisfactory state by having performed the maintenance, nozzle holes of inkjet heads for which discharge data has not been provided for a long time may be dried by airflow caused by scans before when the discharge is started, and in some cases the satisfactory state cannot be maintained. In such a case as well, by having the configuration of the present disclosure, the ink can be discharged under the predetermined discharging condition at the start of the layer formation, whereby the layers can accurately be formed.

Further, in one embodiment of the three-dimensional structure forming device according to the present disclosure, in addition to the above configuration, the control unit 20 controls the recording unit 10 to preliminarily discharge the ink for each of the at least one scan.

According to the above configuration, since the preliminary ink discharge is performed for each scan, the formation of the layers 5a(1), 5a(2), . . . can more accurately be performed.

Further, in one embodiment of the three-dimensional structure forming device according to the present disclosure, in addition to the above configuration, the recording unit 10 discharges one or more types of object-forming ink for forming the model main body portion and one or more types of coloring ink for forming the colored portion, as the ink, from the nozzle heads provided respectively, and the control unit controls the recording unit 10 to preliminarily discharge the ink from at least one of the nozzle heads.

Further, in one embodiment of the three-dimensional structure forming device according to the present disclosure, in addition to the above configuration, the control unit 20 controls the recording unit to preliminarily discharge the ink from the nozzle head provided for the coloring ink.

According to the above configuration, since the ink for configuring the colored portion is discharged preliminarily, color tone of the three-dimensional structure 5 is controlled highly accurately, and a three-dimensional structure 5 with a desired color tone can be provided.

Further, in one embodiment of the three-dimensional structure forming device according to the present disclosure, in addition to the above configuration, the recording unit 10 discharges the supporting material ink that is not contained in the three-dimensional structure 5, and causes the supporting material ink to deposit along the outer circumference of the layers 5a(1), 5a(2), . . . for the at least one scan (one portion 66, 66′ of the supporting material), and the control unit 20 controls the recording unit 10 to cause the ink that is preliminarily discharged to deposit (preliminarily discharged deposit 7) within the deposited region of the supporting material ink (one portion 66′ of the supporting material).

According to the above configuration, since the preliminarily discharged ink (preliminarily discharged deposit 7) is deposited in the deposit of the supporting material ink (one portion 66′ of the supporting material), the preliminarily discharged ink (preliminarily discharged deposit 7) can be removed at the same time upon removing the deposit of the supporting material ink (one portion 66′ of the supporting material). Due to this, the preliminarily discharged ink (preliminarily discharged deposit 7) does not need to be removed separately, and the forming process can be simplified.

Further, in one embodiment of the three-dimensional structure forming device according to the present disclosure, in addition to the above configuration, the stage 40 for depositing ink discharged from the recording unit 10 is further provided, wherein the ink that is preliminarily discharged by the recording unit 10 may strike onto the stage 40.

According to the above configuration, ink that is preliminarily discharged is caused to strike onto the stage 40 for forming the three-dimensional structure 5. Due to this, as compared to the case of preliminarily discharging the ink on the maintenance unit 30, the ink can be discharged preliminarily in the vicinity of the three-dimensional structure 5, and thus the nozzle units of the inkjet head 11 of the recording unit 10 (first inkjet head nozzle unit 11A, second inkjet head nozzle unit 11B, and third inkjet head nozzle unit 11C) can be prevented from drying up, and discharge-related defect can more efficiently be prevented.

Further, in one embodiment of the three-dimensional structure forming device according to the present disclosure, in addition to the above configuration, a discharging amount of the ink that is preliminarily discharged per unit area may be less than a discharging amount of the ink discharged for forming one of the layers 5a(1), 5a(2), . . . per unit area.

According to the above configuration, the ink that is preliminarily discharged is reduced, so that ink consumption can be suppressed.

Further, according to the present disclosure, an embodiment of the three-dimensional structure forming method for forming the three-dimensional structure 5 including the model main body portion and the colored portion in which a surface thereof is colored, by laminating layers 5a(1), 5a(2), . . . formed by depositing the ink using the three-dimensional structure forming device 60 that is provided with the recording unit 10 and the maintenance unit 30, is characteristic in including: the recording step of causing the recording unit 10 to perform at least one scan, and forming at least one of the layers 5a(1), 5a(2), . . . by discharging the ink from the recording unit 10; and the preliminary discharging step of preliminarily discharging the ink from the recording unit 10 while the recording unit 10 is between the position to receive the maintenance by the maintenance unit 30 and the position to start the layer formation.

According to the above configuration, the ink discharge can be performed under a predetermined discharging condition from the start of the layer formation, and the three-dimensional structure can be formed highly accurately.

Specifically, according to the above configuration, the recording unit 10 is configured to preliminarily discharge the ink while being between the position to receive the maintenance and the position to start layer formation. Due to this, the ink discharging condition of the recording unit can be brought to a state suitable for the layer formation just before the layer formation.

For example, when there is a period during which the ink is not discharged before starting the ink discharge for the layer formation, there are cases where the ink discharging condition of the recording unit 10 changes in an undesirable manner, such as by the holes for discharging the ink of the recording unit 10 becoming dry. However, according to the above configuration, since the ink is preliminarily discharged before the layer formation, this preliminary ink discharge can optimize the ink discharging condition of the recording unit 10. Due to this, the layer formation can be started under the optimal ink discharging condition.

It should be noted that the same applies to a period from just after the recording unit 10 has received maintenance (for example, wiping, capping, and flushing) by the maintenance unit 30 to the start of the layer formation. That is, even if the recording unit 10 comes to be in the satisfactory state by the maintenance, since time will pass until when the layer formation is started, so in some cases, the satisfactory state cannot be maintained. Even in such a case, by having the configuration of the present disclosure, the ink can be discharged under the predetermined discharging condition at the start of the layer formation, whereby the layers can accurately be formed.

The present disclosure is not limited to the respective embodiments as described above, and various modifications can be made within the scope indicated in the claims; further, the embodiments obtained by suitably combining the technical features respectively disclosed in different embodiments are also included within the technical scope of the present disclosure.

The present disclosure can be applied to any forming device for forming a three-dimensional structure.

What is claimed is:

1. A three-dimensional structure forming method for forming a three-dimensional structure including an object and a colored region in which a surface of the object is colored, by using a three-dimensional structure forming device equipped with a recording unit and a maintenance unit for laminating layers formed by depositing ink, and the three-dimensional structure forming method comprising:
a recording step of causing the recording unit to perform scans, and discharging the ink from the recording unit during the scans to form the layers; and
a preliminary discharging step of preliminarily discharging the ink from the recording unit while being between a position to be performed maintenance by the maintenance unit and a position to start to form the layers.

2. The three-dimensional structure forming method according to claim 1, wherein
the preliminary discharging step is performed for each of the scans.

3. The three-dimensional structure forming method according to claim 1, wherein
the recording step discharges one or more types of object-forming ink for forming the object and one or more types of coloring ink for forming the colored region, as the ink, from inkjet heads provided respectively, and
the preliminary discharging step discharges the ink from at least one of the inkjet heads.

4. The three-dimensional structure forming method according to claim 2, wherein
the recording step discharges one or more types of object-forming ink for forming the object and one or more types of coloring ink for forming the colored region, as the ink, from inkjet heads provided respectively, and
the preliminary discharging step discharges the ink from at least one of the inkjet heads.

5. The three-dimensional structure forming method according to claim 3, wherein
the preliminary discharging step discharges the ink from the inkjet head provided for the coloring ink.

6. The three-dimensional structure forming method according to claim 4, wherein
the preliminary discharging step discharges the ink from the inkjet head provided for the coloring ink.

7. The three-dimensional structure forming method according to claim 1, wherein
the recording step discharges supporting material ink that is not contained in the three-dimensional structure, and causes the supporting material ink to deposit along an outer circumference of the layers for each of the scans, and
the ink that is discharged by the preliminary discharging step is deposited within a deposited region of the supporting material ink.

8. The three-dimensional structure forming method according to claim 1, further comprising:
providing a stage for depositing the ink that is discharged,
wherein the ink of the preliminary discharging step strikes onto an upper surface of the stage.

9. The three-dimensional structure forming method according to claim 1, wherein
a discharging amount per unit area of the ink in the preliminary discharging step is less than a discharging amount per unit area of the ink discharged for forming one of the layers.

10. The three-dimensional structure forming method according to claim 1, wherein
the recording step discharges supporting material ink that is not contained in the three-dimensional structure, and causes the supporting material ink to deposit along an outer circumference of the layers for each of the scans to form a supporting material,
the supporting material supports or holds the three-dimensional structure in a forming process, and is removed in a post-processing,
the ink discharged in the preliminary discharging step is discharged in the supporting material or at a position outside the supporting material, and is discharged at a position outside a portion of the supporting material.

11. The three-dimensional structure forming method according to claim 1, wherein
the recording step discharges the ink based on multilayer pattern data,
the preliminary discharging step discharges the ink from the recording unit based on data different from the multilayer pattern data.
